(19) United States
(12) Patent Application Publication
(10) Pub. No.: US 2018/0245507 A1
(43) Pub. Date: Aug. 30, 2018

(54) EXHAUST SYSTEM OF INTERNAL COMBUSTION ENGINE

(71) Applicant: Toyota Jidosha Kabushiki Kaisha, Toyota-shi Aichi-ken (JP)

(72) Inventor: Koichi Kitaura, Odawara-shi Kanagawa-ken (JP)

(73) Assignee: Toyota Jidosha Kabushiki Kaisha, Toyota-shi Aichi-ken (JP)

(21) Appl. No.: 15/902,387

(22) Filed: Feb. 22, 2018

(30) Foreign Application Priority Data
Feb. 24, 2017 (JP) 2017-032920

(51) Int. Cl. F02B 37/18; F01N 3/20; F02B 37/22; F02B 37/02

(52) U.S. Cl. CPC F02B 37/183; F01N 3/20; F05D 2220/40; F02B 37/025; F02B 37/225

(57) ABSTRACT

An exhaust system includes an electronic control unit that is configured to control a turbo bypass valve to be in a fully closed state and control an opening degree of a wastegate valve to a first predetermined opening degree during execution of fuel cut control, and maintain the turbo bypass valve in the fully closed state and control an opening degree of the wastegate valve to a second predetermined opening degree when a boost request is not made for the internal combustion engine at the end of the fuel cut control. An area of inflow of bypass gas on an upstream side end surface of the three-way catalyst when the opening degree of the wastegate valve is controlled to the first predetermined opening degree is in a different position from when the opening degree of the wastegate valve is controlled to the second predetermined opening degree.

### CROSS-REFERENCE TO RELATED APPLICATIONS

This application claims priority to Japanese Patent Application No. 2017-032920 filed on Feb. 24, 2017, which is incorporated herein by reference in its entirety including the specification, drawings and abstract.

### BACKGROUND

### 1. Technical Field

The present disclosure relates to an exhaust system of an internal combustion engine that includes a turbocharger.

### 2. Description of Related Art

A bypass passage that bypasses a turbine of a turbocharger is disposed in a configuration in which the turbine is disposed in an exhaust passage of an internal combustion engine. A wastegate valve (hereinafter, referred to as “WGV”) that is configured to change the channel cross-sectional area of exhaust gas is disposed at the exit of the bypass passage. An exhaust control catalyst may be disposed downstream of a merging portion of the exhaust passage where the bypass passage merges with the exhaust passage.

A technology that uses the opening degree of a wastegate valve (bypass valve) to control the flow direction of exhaust gas discharged from a bypass passage bypassing a turbine is disclosed in Japanese Unexamined Patent Application Publication No. 2012-002094 (JP 2012-002094 A). When there is a possibility of an excessive increase in the temperature of an exhaust control catalyst that is disposed downstream of a merging portion of an exhaust passage where the bypass passage merges with the exhaust passage, the technology disclosed in JP 2012-002094 A controls the opening degree of the wastegate valve such that the exhaust gas discharged from the bypass passage hits the wall of the exhaust passage.

A technology disclosed in Japanese Unexamined Patent Application Publication No. 2010-180781 (JP 2010-180781 A) also uses the opening degree of a wastegate valve to control the flow direction of exhaust gas, discharged from a bypass passage, with respect to an exhaust control catalyst that is disposed downstream of a merging portion of an exhaust passage where the bypass passage merges with the exhaust passage. When an internal combustion engine is cold-started, the technology disclosed in JP 2010-180781 A sets the opening degree of the wastegate valve such that the exhaust gas discharged from the bypass passage directly hits the exhaust control catalyst. When the wastegate valve is controlled to decrease a boost pressure during high load operation of the internal combustion engine, the technology sets the opening degree of the wastegate valve such that the exhaust gas discharged from the bypass passage does not directly hit the exhaust control catalyst.

### SUMMARY

When a decelerating operation of an internal combustion engine is performed, so-called fuel cut control that stops fuel injection in the internal combustion engine may be executed. When the fuel cut control is executed in a configuration in which a three-way catalyst is disposed as an exhaust control catalyst in an exhaust passage of the internal combustion engine, air flows to the three-way catalyst. Consequently, the three-way catalyst may be oxidized. Then, at the end of the fuel cut control (that is, when fuel injection is resumed in the internal combustion engine), there is a possibility of a decrease in the NOx control efficiency of the three-way catalyst while the three-way catalyst is sufficiently reduced. Such a phenomenon may also occur in a configuration in which a three-way catalyst is disposed in an exhaust passage downstream of a merging portion of the exhaust passage where a bypass passage merges with the exhaust passage that bypasses a turbine of a turbocharger.

The present disclosure provides an exhaust system of an internal combustion engine that suppresses a decrease in the NOx control efficiency of a three-way catalyst at the end of fuel cut control in a configuration in which the three-way catalyst is disposed in an exhaust passage of the internal combustion engine.

An aspect of the present disclosure relates to an exhaust system of an internal combustion engine. The exhaust system includes a turbocharger that includes a turbine disposed in an exhaust passage of the internal combustion engine, and a compressor disposed in an intake passage of the internal combustion engine; a bypass passage that branches off from the exhaust passage upstream of the turbine and merges with the exhaust passage downstream of the turbine; a wastegate valve that is disposed at an exit of the bypass passage and is configured to change a channel cross-sectional area of gas at the exit of the bypass passage, the wastegate valve including a valve body portion supported on a single side, the wastegate valve being configured to change an opening degree by swinging the valve body portion, the wastegate valve being configured to change a flow direction of bypass gas in accordance with the change in opening degree, and the bypass gas being gas flowing out from the exit of the bypass passage; a turbo bypass valve that is disposed between a branch portion of the exhaust passage where the bypass passage branches off from the exhaust passage, and a merging portion of the exhaust passage where the bypass passage merges with the exhaust passage, and is configured to change the channel cross-sectional area of gas passing through the turbine; a three-way catalyst that is disposed immediately downstream of the merging portion of the exhaust passage where the bypass passage merges with the exhaust passage, the three-way catalyst being disposed in a position in which an area of inflow of the bypass gas on an upstream side end surface of the three-way catalyst is changed in accordance with the change in the flow direction of the bypass gas; and an electronic control unit. The electronic control unit is configured to execute fuel cut control that stops fuel injection to the internal combustion engine, at a time of a decelerating operation. The electronic control unit is configured to control the turbo bypass valve to be in a fully closed state and controls the opening degree of the wastegate valve to a first predetermined opening degree during execution of the fuel cut control. The electronic control unit is configured to maintain the turbo bypass valve in the fully closed state and controls the opening degree of the wastegate valve to a second predetermined opening degree different from the first predetermined opening degree when a boost request is not made for the internal combustion engine at an end of the fuel cut control. The wastegate valve and the three-way catalyst are configured such that an area of inflow of the bypass gas on the upstream side end surface of the three-way catalyst when the opening degree of the wastegate valve is controlled to the first predetermined opening degree is in a different position from the area of inflow of the bypass gas on the upstream side end surface of the three-way catalyst when the opening degree of the wastegate valve is controlled to the second predetermined opening degree.

The internal combustion engine according to the aspect of the present disclosure includes the electronic control unit that executes the fuel cut control. During execution of the fuel cut control, air that flows into the internal combustion engine is discharged from the internal combustion engine without being supplied for combustion. Thus, gas that flows into the three-way catalyst through the exhaust passage during execution of the fuel cut control is air. When the fuel cut control is ended, gas that flows into the three-way catalyst is exhaust gas (burnt gas).

The internal combustion engine according to the aspect of the present disclosure includes the turbocharger. The wastegate valve is disposed at the exit of the bypass passage that bypasses the turbine of the turbocharger. The turbo bypass valve (hereinafter, referred to as “TBV”) is disposed between the branch portion of the exhaust passage where the bypass passage branches off from the exhaust passage, and the merging portion of the exhaust passage where the bypass passage merges with the exhaust passage. In such a configuration, the channel cross-sectional area of exhaust gas passing through the turbine is changed by adjusting the opening degree of the turbo bypass valve. Accordingly, the flow rate of exhaust gas passing through the turbine can be directly controlled. In the aspect of the present disclosure, the electronic control unit controls the turbo bypass valve to be in the fully closed state and sets the wastegate valve to an opened state during execution of the fuel cut control. The electronic control unit maintains the turbo bypass valve in the fully closed state and sets the wastegate valve to the opened state even when a boost request is not made for the internal combustion engine at the end of the fuel cut control. Accordingly, approximately the whole amount of gas (air) discharged from the internal combustion engine can flow through the bypass passage.

The wastegate valve according to the aspect of the present disclosure has a structure in which the opening degree of the wastegate valve is changed by swinging the valve body portion in a state in which a single side of the valve body portion of the wastegate valve is supported. When the opening degree of the wastegate valve is changed, the flow direction of bypass gas that is gas flowing out from the exit of the bypass passage is changed. That is, when the wastegate valve is in the opened state, the flow of the bypass gas is guided by the wastegate valve. In the aspect of the present disclosure, the three-way catalyst is disposed immediately downstream of the merging portion of the exhaust passage where the bypass passage merges with the exhaust passage. More specifically, the three-way catalyst is disposed in a position in which the area of inflow of the bypass gas on the upstream side end surface of the three-way catalyst is changed when the flow direction of the bypass gas is changed.

In the aspect of the present disclosure, the electronic control unit controls the opening degree of the wastegate valve to the first predetermined opening degree during execution of the fuel cut control. When a boost request is not made for the internal combustion engine at the end of the fuel cut control, the electronic control unit sets the opening degree of the wastegate valve to the second predetermined opening degree different from the first predetermined opening degree. The wastegate valve and the three-way catalyst are configured such that the area of inflow of the bypass gas when the opening degree of the wastegate valve is controlled to the first predetermined opening degree is in a different position on the upstream side end surface of the three-way catalyst from the area of inflow of the bypass gas when the opening degree of the wastegate valve is controlled to the second predetermined opening degree.

According to the aspect of the present disclosure, during execution of the fuel cut control, gas (air) that is discharged from the internal combustion engine flows into the three-way catalyst from a partial area of the upstream side end surface of the three-way catalyst and not from the entire upstream side end surface of the three-way catalyst. Consequently, air flows through the three-way catalyst through a partial area in the horizontal cross-sectional direction of the three-way catalyst and not through the entire area in the horizontal cross-sectional direction of the three-way catalyst. Accordingly, a part of the three-way catalyst that is oxidized during execution of the fuel cut control can be restricted to a part of the three-way catalyst. At the end of the fuel cut control, gas (exhaust gas) that is discharged from the internal combustion engine flows into the three-way catalyst from an area different from the area of inflow of gas during execution of the fuel cut control on the upstream side end surface of the three-way catalyst. Consequently, exhaust gas flows through the three-way catalyst through an area in the horizontal cross-sectional direction of the three-way catalyst other than the area of the three-way catalyst that is oxidized during execution of the fuel cut control. That is, at the end of the fuel cut control, exhaust gas flows through a part of the three-way catalyst in which the NOx control function works more effectively.

Accordingly, according to the aspect of the present disclosure, a decrease in the NOx control efficiency of the three-way catalyst at the end of the fuel cut control can be suppressed. In the aspect of the present disclosure, the area of the three-way catalyst through which all gas flows when the opening degree of the wastegate valve is controlled to the first predetermined opening degree does not need to be completely different from when the opening degree of the wastegate valve is controlled to the second predetermined opening degree. The area of the three-way catalyst through which gas mainly flows when the opening degree of the wastegate valve is controlled to the first predetermined opening degree may be different from when the opening degree of the wastegate valve is controlled to the second predetermined opening degree.

In the exhaust system according to the aspect of the present disclosure, the bypass gas can be guided in the direction of a peripheral side on the upstream side end surface of the three-way catalyst by setting the opening degree of the wastegate valve to a comparatively small opening degree. The bypass gas can be guided in the direction of the vicinity of the center portion on the upstream side end surface of the three-way catalyst by setting the opening degree of the wastegate valve to a comparatively large opening degree.

According to the aspect of the present disclosure, a decrease in the NOx control efficiency of the three-way catalyst at the end of the fuel cut control can be suppressed.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a diagram illustrating a schematic configuration of an internal combustion engine and an intake and exhaust system of the internal combustion engine according to an embodiment;

FIG. 2 is a diagram illustrating a schematic configuration of a wastegate valve according to the embodiment;

FIG. 3 is a diagram illustrating the opening degrees of a turbo bypass valve and the wastegate valve and the flow of bypass gas (air) during execution of fuel cut control;

FIG. 4 is a diagram illustrating the opening degrees of the turbo bypass valve and the wastegate valve and the flow of bypass gas (exhaust gas) when a boost request is not made for the internal combustion engine at the end of the fuel cut control;

FIG. 5A is a diagram for describing an area of inflow of bypass gas on the upstream side end surface of a three-way catalyst;

FIG. 5B is a diagram for describing the area of inflow of the bypass gas on the upstream side end surface of the three-way catalyst;

FIG. 6 is a diagram illustrating the opening degrees of the turbo bypass valve and the wastegate valve and the flow of gas (exhaust gas) when a boost request is made for the internal combustion engine at the end of the fuel cut control;

FIG. 7 is a flowchart illustrating a flow of control of the opening degrees of the turbo bypass valve and the wastegate valve at the time of execution of the fuel cut control;

FIG. 8 is a flowchart illustrating a flow of control of the opening degrees of the turbo bypass valve and the wastegate valve at the end of the fuel cut control; and

FIG. 9 is a flowchart illustrating a flow of an enrichment process according to a second embodiment.

### DETAILED DESCRIPTION OF EMBODIMENTS

Specific embodiments of the present disclosure will be described below based on the drawings. Dimensions, materials, shapes, relative arrangements, and the like of constituent components disclosed in the embodiments are not intended to limit the technical scope of the present disclosure thereto unless otherwise specified.

### First Embodiment

Schematic Configuration

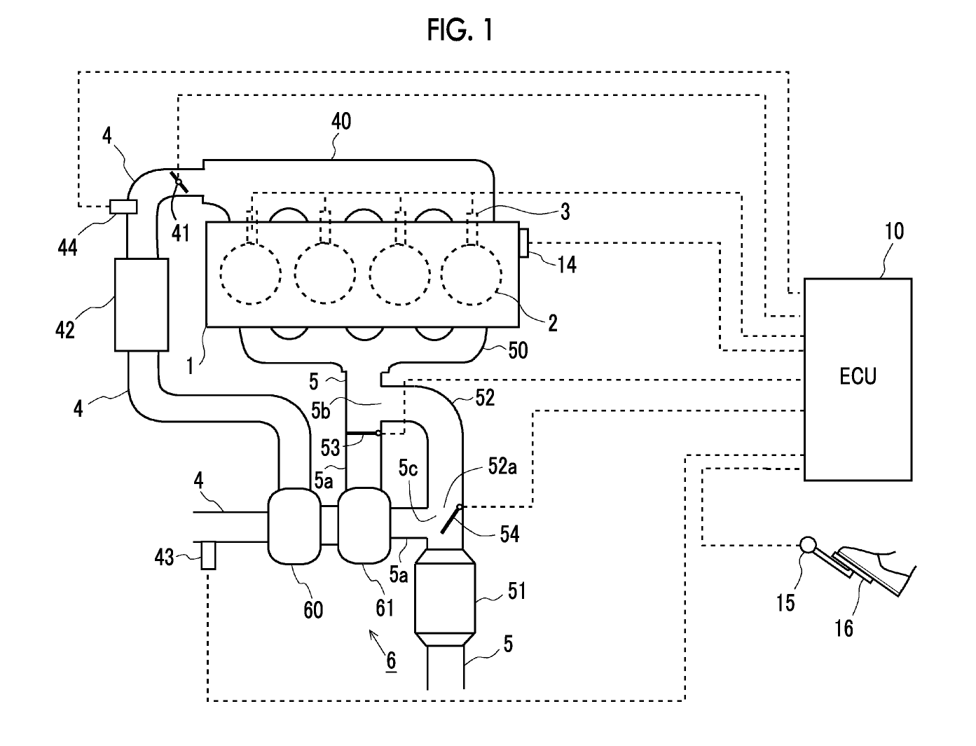

An embodiment of the present disclosure will be described below by using the drawings. FIG. 1 is a diagram illustrating a schematic configuration of an internal combustion engine and an intake and exhaust system of the internal combustion engine according to the present embodiment. An internal combustion engine 1 illustrated in FIG. 1 is a spark-ignition internal combustion engine (gasoline engine) that includes a cylinder group including four cylinders 2. A fuel injection valve 3 that injects fuel to each intake port is disposed in the internal combustion engine 1. The fuel injection valve 3 may be configured to directly inject fuel into each cylinder 2. An ignition plug (not illustrated) for igniting an air-fuel mixture within each cylinder is attached to each cylinder 2.

The internal combustion engine 1 is connected with an intake manifold 40 and an exhaust manifold 50. An intake passage 4 is connected to the intake manifold 40. A compressor 60 of a turbocharger 6 that operates with the energy of exhaust gas as a drive source is disposed in the middle of the intake passage 4. An intercooler 42 that exchanges heat between intake air and outside air is disposed in the intake passage 4 downstream of the compressor 60. A throttle valve 41 is disposed in the intake passage 4 downstream of the intercooler 42. The throttle valve 41 adjusts the amount of air taken into the internal combustion engine 1 by changing the channel cross-sectional area of the intake air in the intake passage 4. A pressure sensor 44 is disposed in the intake passage 4 upstream of the throttle valve 41. The pressure sensor 44 outputs an electrical signal that corresponds to the pressure of intake air on the upstream side of the throttle valve 41 (that is, a boost pressure). An air flow meter 43 is disposed in the intake passage 4 upstream of the compressor 60. The air flow meter 43 outputs an electrical signal that corresponds to the amount (mass) of intake air (air) flowing within the intake passage 4.

A turbine 61 of the turbocharger 6 is disposed in the middle of an exhaust passage 5. A bypass passage 52 that bypasses the turbine 61 is disposed in the exhaust passage 5. The bypass passage 52 branches off from a branch portion 5b of the exhaust passage 5 upstream of the turbine 61, and merges with a merging portion 5c of the exhaust passage 5 downstream of the turbine 61. The exhaust passage 5 from the branch portion 5b to the merging portion 5c through the turbine 61 will be referred to as a turbine side exhaust passage 5a. A turbo bypass valve (TBV) 53 is disposed between the branch portion 5b and the turbine 61 in the turbine side exhaust passage 5a. The turbo bypass valve 53 adjusts the flow rate of exhaust gas passing through the turbine 61 by changing the channel cross-sectional area of exhaust gas flowing in the turbine side exhaust passage 5a (that is, exhaust gas passing through the turbine 61). The turbo bypass valve 53 may be disposed between the turbine 61 and the merging portion 5c in the turbine side exhaust passage 5a.

A wastegate valve (WGV) 54 is disposed at an exit 52a of the bypass passage 52. The wastegate valve 54 adjusts the flow rate of exhaust gas flowing in the bypass passage 52 by changing the channel cross-sectional area of exhaust gas at the exit 52a of the bypass passage 52. A three-way catalyst 51 as an exhaust control catalyst is disposed immediately downstream of the merging portion 5c of the exhaust passage 5.

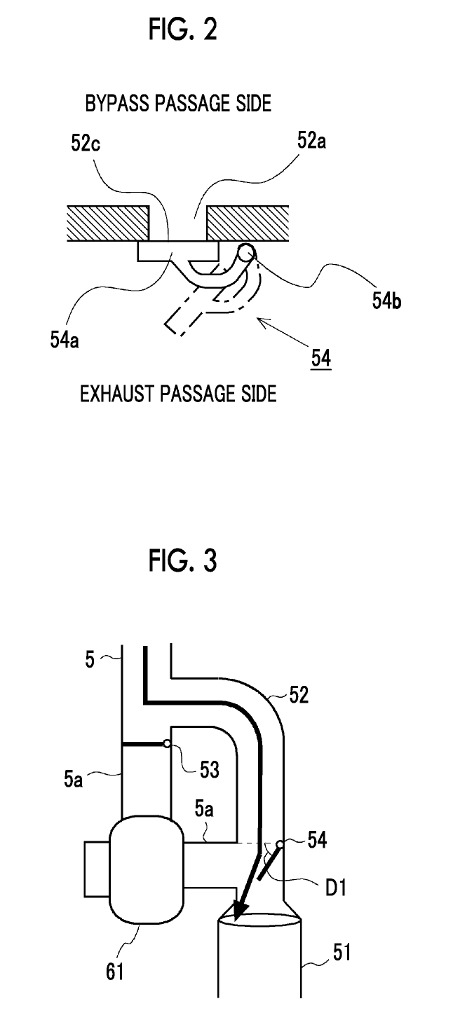

FIG. 2 is a diagram illustrating a schematic configuration of the wastegate valve 54. In FIG. 2, a solid line illustrates the wastegate valve 54 in a closed state, and a dot-dashed line illustrates the wastegate valve 54 in an opened state. The wastegate valve 54 has a structure in which a single side of a valve body portion 54a of the wastegate valve is supported by a drive shaft 54b. Accordingly, when the drive shaft 54b is rotated by an actuator (not illustrated), the valve body portion 54a is swung about the drive shaft 54b, and the opening degree of the wastegate valve 54 is changed. When the opening degree of the wastegate valve 54 is changed, the flow direction of bypass gas that is gas flowing out from the exit 52a of the bypass passage 52 is changed. That is, when the wastegate valve 54 is in the opened state, the flow of bypass gas is guided by a closing surface (a surface that closes the exit 52a of the bypass passage 52 when the wastegate valve 54 is closed) 54c of the valve body portion 54a of the wastegate valve 54. Furthermore, when the flow direction of bypass gas is changed by changing the opening degree of the wastegate valve 54, an area of inflow of the bypass gas on the upstream side end surface of the three-way catalyst 51 is changed, since the three-way catalyst 51 is disposed immediately downstream of the merging portion 5c of the exhaust passage 5 in the present embodiment. A correlation between the opening degree of the wastegate valve 54 and the area of inflow of the bypass gas on the upstream side end surface of the three-way catalyst 51 will be described below.

An electronic control unit (ECU) 10 is disposed along with the internal combustion engine 1. The ECU 10 is a unit that controls the operating state and the like of the internal combustion engine 1. Various sensors such as a crank position sensor 14 and an accelerator position sensor 15 in addition to the air flow meter 43 and the pressure sensor 44 are electrically connected to the ECU 10. The crank position sensor 14 is a sensor that outputs an electrical signal correlating with the rotated position of an engine output shaft (crankshaft) of the internal combustion engine 1. The accelerator position sensor 15 is a sensor that outputs an electrical signal correlating with the operation amount of an accelerator pedal 16 (accelerator operation amount) of a vehicle in which the internal combustion engine 1 is mounted. The output signals of the sensors are input into the ECU 10. The ECU 10 derives the engine rotational speed of the internal combustion engine 1 from the detected value of the crank position sensor 14, and derives the engine load of the internal combustion engine 1 from the detected value of the accelerator position sensor 15.

Various devices such as each fuel injection valve 3, the throttle valve 41, the turbo bypass valve 53, and the wastegate valve 54 are electrically connected to the ECU 10. The ECU 10 controls the devices based on the detected value of each sensor. That is, the opening degree of each of the throttle valve 41, the turbo bypass valve 53, and the wastegate valve 54 is controlled by the ECU 10. The ECU 10 that controls the opening degree of each of the turbo bypass valve 53 and the wastegate valve 54 in the present embodiment is one example of a “valve controller” according to the present disclosure.

Fuel Cut Control

When the operating state of the internal combustion engine is changed to a decelerating operation, fuel cut control that stops fuel injection from each fuel injection valve is executed in the internal combustion engine 1 according to the present embodiment. When the fuel cut control is executed, air that flows into the internal combustion engine 1 is discharged from the internal combustion engine 1 without being supplied for combustion. Consequently, air flows into the three-way catalyst 51, and a large amount of oxygen is supplied to the three-way catalyst 51. Then, the three-way catalyst 51 may be oxidized (that is, oxygen storage material and precious metal in the three-way catalyst 51 may be oxidized).

Even when the three-way catalyst 51 is oxidized during execution of the fuel cut control, exhaust gas (that is, burnt gas) flows into the three-way catalyst 51 at the end of the fuel cut control, and oxygen that is retained in the three-way catalyst 51 is consumed in oxidation of a fuel component in the exhaust gas. Thus, the three-way catalyst 51 is reduced. However, a certain period of time is taken for sufficient reduction of the three-way catalyst 51 after the end of the fuel cut control, that is, resumption of fuel injection from each fuel injection valve 3. In the three-way catalyst 51, oxygen storage material such as cerium oxide (CeO₂) is reduced, and then, precious metal such as rhodium (Rh) is reduced. Thus, when the three-way catalyst 51 is oxidized during execution of the fuel cut control, there is a possibility of a decrease in the NOx control efficiency of the three-way catalyst 51 (the ratio of the amount of reduced NOx in the three-way catalyst 51 to the amount of NOx flowing into the three-way catalyst 51) while the three-way catalyst 51 is sufficiently reduced after the end of the fuel cut control.

Control of Opening Degrees of Turbo Bypass Valve and Wastegate Valve

In the present embodiment, the opening degrees of the turbo bypass valve 53 and the wastegate valve 54 are controlled during execution of the fuel cut control and at the end of the fuel cut control, in order to suppress such a decrease in the NOx control efficiency of the three-way catalyst 51 at the end of the fuel cut control. Specifically, the turbo bypass valve 53 is controlled to be in a fully closed state during execution of the fuel cut control. When a boost request is not made for the internal combustion engine 1 at the end of the fuel cut control, the turbo bypass valve 53 is maintained in the fully closed state. While the turbo bypass valve 53 is controlled to be in the fully closed state, the wastegate valve 54 is set to the opened state. Accordingly, approximately the whole amount of gas (air during execution of the fuel cut control; exhaust gas (burnt gas) at the end of the fuel cut control) discharged from the internal combustion engine 1 flows through the bypass passage 52.

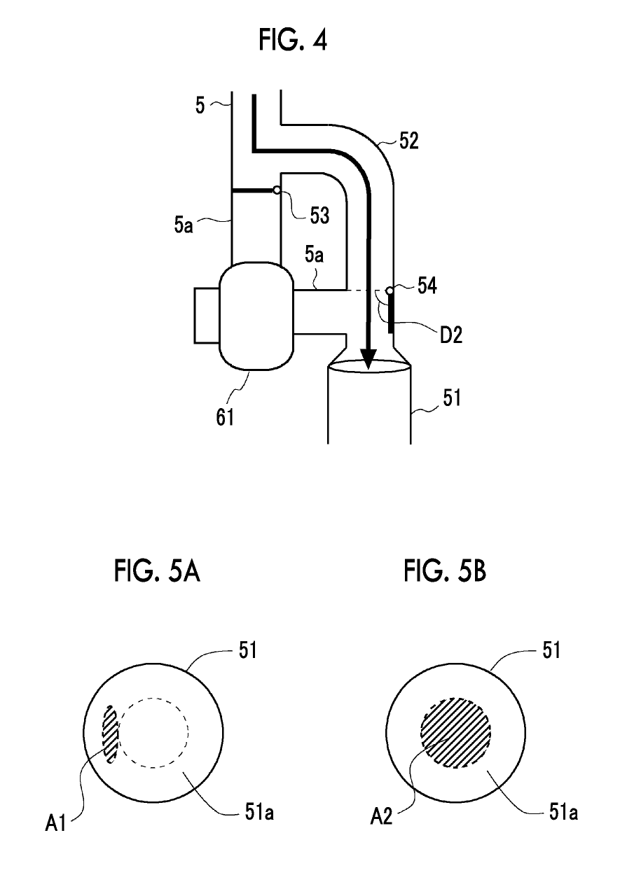

The opening degree of the wastegate valve 54 during execution of the fuel cut control is controlled to be different from the opening degree of the wastegate valve 54 at the end of the fuel cut control. Thus, the area of inflow of the bypass gas on the upstream side end surface of the three-way catalyst 51 during execution of the fuel cut control is different from the area of inflow of the bypass gas at the end of the fuel cut control. The opening degree of the wastegate valve 54 during execution of the fuel cut control and at the end of the fuel cut control according to the present embodiment will be described based on FIG. 3 to FIG. 5B. FIG. 3 is a diagram illustrating the opening degrees of the turbo bypass valve 53 and the wastegate valve 54 and the flow of bypass gas (air) during execution of the fuel cut control. FIG. 4 is a diagram illustrating the opening degrees of the turbo bypass valve 53 and the wastegate valve 54 and the flow of bypass gas (exhaust) when a boost request is not made for the internal combustion engine 1 at the end of the fuel cut control. In FIG. 3 and FIG. 4, an arrow illustrates the flow of gas. As described above, the turbo bypass valve 53 is controlled to be in the fully closed state in any of FIG. 3 and FIG. 4.

FIG. 5A and FIG. 5B are diagrams for describing the area of inflow of the bypass gas on the upstream side end surface of the three-way catalyst 51. A hatched portion A1 in FIG. 5A illustrates the area of inflow of the bypass gas on an upstream side end surface 51a of the three-way catalyst 51 during execution of the fuel cut control. That is, the hatched portion A1 in FIG. 5A illustrates the area of inflow of the bypass gas on the upstream side end surface 51a of the three-way catalyst 51 when the opening degree of the wastegate valve 54 is controlled to the opening degree illustrated in FIG. 3. Hereinafter, the area illustrated by the hatched portion A1 in FIG. 5A will be referred to as a first predetermined area. A hatched portion A2 in FIG. 5B illustrates the area of inflow of the bypass gas on the upstream side end surface 51a of the three-way catalyst 51 when a boost request is not made for the internal combustion engine 1 at the end of the fuel cut control. That is, the hatched portion A2 in FIG. 5B illustrates the area of inflow of the bypass gas on the upstream side end surface 51a of the three-way catalyst 51 when the opening degree of the wastegate valve 54 is controlled to the opening degree illustrated in FIG. 4. Hereinafter, the area illustrated by the hatched portion A2 in FIG. 5B will be referred to as a second predetermined area.

As described above, when the opening degree of the wastegate valve 54 is changed, the flow direction of the bypass gas is changed in the present embodiment. Furthermore, when the flow direction of the bypass gas is changed by changing the opening degree of the wastegate valve 54, the area of inflow of the bypass gas on the upstream side end surface of the three-way catalyst 51 is changed. During execution of the fuel cut control, the opening degree of the wastegate valve 54 is controlled to a first predetermined opening degree D1 as illustrated in FIG. 3. The first predetermined opening degree D1 is a comparatively small opening degree. When the opening degree of the wastegate valve 54 is controlled to the first predetermined opening degree D1, the bypass gas immediately downstream of the merging portion 5c in the exhaust passage 5 is guided to flow along the outer side from the vicinity of the center in the exhaust passage 5. When the bypass gas is guided in such a direction, the bypass gas flows into the first predetermined area A1 on the upstream side end surface 51a of the three-way catalyst 51 as illustrated in FIG. 5A. The first predetermined area A1 is an area on the outer side from the second predetermined area A2 that is an area including the center portion on the upstream side end surface 51a of the three-way catalyst 51. In other words, the first predetermined opening degree D1 is set such that the bypass gas flows into the first predetermined area A1 on the upstream side end surface 51a of the three-way catalyst 51. In such a case, the whole amount of bypass gas does not need to flow into the three-way catalyst 51 completely from the first predetermined area A1, and the bypass gas may flow into the three-way catalyst 51 mainly from the first predetermined area A1.

At the end of the fuel cut control, the opening degree of the wastegate valve 54 is controlled to a second predetermined opening degree D2 as illustrated in FIG. 4. The second predetermined opening degree D2 is an opening degree that is larger than the first predetermined opening degree D1. When the opening degree of the wastegate valve 54 is controlled to the second predetermined opening degree D2, the bypass gas immediately downstream of the merging portion 5c in the exhaust passage 5 is guided to flow along the vicinity of the center in the exhaust passage 5. An example of the second predetermined opening degree D2 is an opening degree that corresponds to a fully opened state. When the bypass gas is guided in such a direction, the bypass gas flows into the second predetermined area A2 including the center portion on the upstream side end surface 51a of the three-way catalyst 51 as illustrated in FIG. 5B. In other words, the second predetermined opening degree D2 is set such that the bypass gas flows into the second predetermined area A2 on the upstream side end surface 51a of the three-way catalyst 51. In such a case, the whole amount of bypass gas does not need to flow into the three-way catalyst 51 completely from the second predetermined area A2, and the bypass gas may flow into the three-way catalyst 51 mainly from the second predetermined area A2.

As illustrated in FIG. 5A or FIG. 5B, when the bypass gas flows into the three-way catalyst 51 from a partial area (the first predetermined area A1 or the second predetermined area A2) of the upstream side end surface 51a of the three-way catalyst 51 and not from the entire upstream side end surface 51a of the three-way catalyst 51, a bypass passes through the three-way catalyst 51 through a partial area in the horizontal cross-sectional direction of the three-way catalyst 51 and not through the entire area in the horizontal cross-sectional direction of the three-way catalyst 51. That is, as illustrated in FIG. 5A, when the bypass gas flows into the three-way catalyst 51 from the first predetermined area A1 in the upstream side end surface 51a of the three-way catalyst 51, a bypass passes through a part of the three-way catalyst 51 that has the first predetermined area A1 as the upstream side end surface and extends in the axial direction of the three-way catalyst 51. As illustrated in FIG. 5B, when the bypass gas flows into the three-way catalyst 51 from the second predetermined area A2 in the upstream side end surface 51a of the three-way catalyst 51, a bypass passes through a part of the three-way catalyst 51 that has the second predetermined area A2 as the upstream side end surface and extends in the axial direction of the three-way catalyst 51. Accordingly, the area in the horizontal cross-sectional direction of the three-way catalyst 51 through which the bypass gas flows when the bypass gas flows into the three-way catalyst 51 from the first predetermined area A1 in the upstream side end surface 51a of the three-way catalyst 51 (FIG. 5A) is different from the area in the horizontal cross-sectional direction of the three-way catalyst 51 through which the bypass gas flows when the bypass gas flows into the three-way catalyst 51 from the second predetermined area A2 in the upstream side end surface 51a of the three-way catalyst 51 (FIG. 5B).

As described above, during execution of the fuel cut control, the bypass gas is guided such that the bypass gas (air) flows into the three-way catalyst 51 from the first predetermined area A1 in the upstream side end surface 51a of the three-way catalyst 51. Thus, a part of the three-way catalyst 51 that is oxidized during execution of the fuel cut control can be restricted to a part of the three-way catalyst 51, that is, the part of the three-way catalyst 51 that has the first predetermined area A1 as the upstream side end surface and extends in the axial direction of the three-way catalyst 51. That is, oxidation of a part of the three-way catalyst 51 other than the part of the three-way catalyst 51 that has the first predetermined area A1 as the upstream side end surface and extends in the axial direction of the three-way catalyst 51 can be suppressed during execution of the fuel cut control.

At the end of the fuel cut control, the bypass gas is guided such that the bypass gas (exhaust gas) flows into the three-way catalyst 51 from the second predetermined area A2 in the upstream side end surface 51a of the three-way catalyst 51. Thus, the bypass gas can flow through a part of the three-way catalyst 51 other than the part of the three-way catalyst 51 oxidized during execution of the fuel cut control, that is, the part of the three-way catalyst 51 that has the second predetermined area A2 as the upstream side end surface and extends in the axial direction of the three-way catalyst 51. That is, at the end of the fuel cut control, the bypass gas can flow through a part of the three-way catalyst 51 in which the NOx control function works more effectively. Accordingly, a decrease in the NOx control efficiency of the three-way catalyst 51 at the end of the fuel cut control can be suppressed.

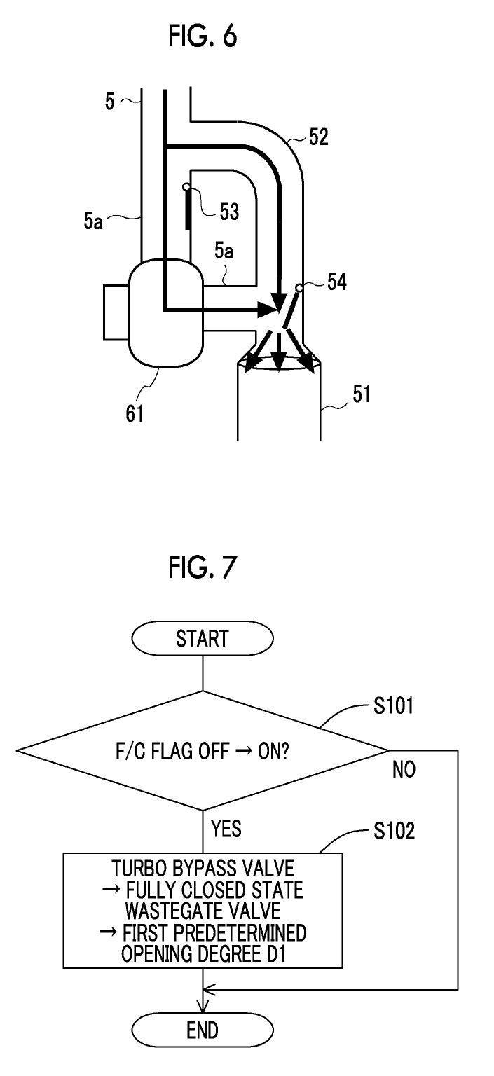

A boost request may be made for the internal combustion engine 1 at the end of the fuel cut control. FIG. 6 is a diagram illustrating the opening degrees of the turbo bypass valve 53 and the wastegate valve 54 and the flow of gas (exhaust gas) when a boost request is made for the internal combustion engine 1 at the end of the fuel cut control in the present embodiment. In FIG. 6 as well, an arrow illustrates the flow of gas. In the present embodiment, the turbo bypass valve 53 is controlled to be in the fully opened state as illustrated in FIG. 6 when a boost request is made for the internal combustion engine 1 at the end of the fuel cut control. The opening degree of the wastegate valve 54 is controlled to an opening degree that corresponds to the requested boost pressure. In such a case, at the end of the fuel cut control, not only the bypass gas (exhaust gas) that is guided by the wastegate valve 54, but also gas (exhaust gas) that passes through the turbine 61 through the turbine side exhaust passage 5a flow into the three-way catalyst 51. Thus, exhaust gas flows into the three-way catalyst 51 from approximately the entire upstream side end surface 51a of the three-way catalyst 51.

Accordingly, exhaust gas flows in the three-way catalyst 51 through approximately the entire area in the horizontal cross-sectional direction of the three-way catalyst 51. Consequently, when a boost request is made for the internal combustion engine 1 at the end of the fuel cut control, exhaust gas also flows through the part of the three-way catalyst 51 that is oxidized during execution of the fuel cut control. However, in the present embodiment, the part of the three-way catalyst 51 that is oxidized during execution of the fuel cut control is restricted to a part of the three-way catalyst 51. Thus, at the end of the fuel cut control, even when exhaust gas flows in the three-way catalyst 51 through approximately the entire area in the horizontal cross-sectional direction of the three-way catalyst 51, a part of the exhaust gas flows through the part of the three-way catalyst 51 other than the part of the three-way catalyst 51 that is oxidized during execution of the fuel cut control. Accordingly, a decrease in the NOx control efficiency of the three-way catalyst 51 at the end of the fuel cut control can be suppressed further than when the three-way catalyst 51 is oxidized across approximately the entire area in the horizontal cross-sectional direction of the three-way catalyst 51 by air that flows into the three-way catalyst 51 from approximately the entire upstream side end surface 51a of the three-way catalyst 51 during execution of the fuel cut control.

Control Flow

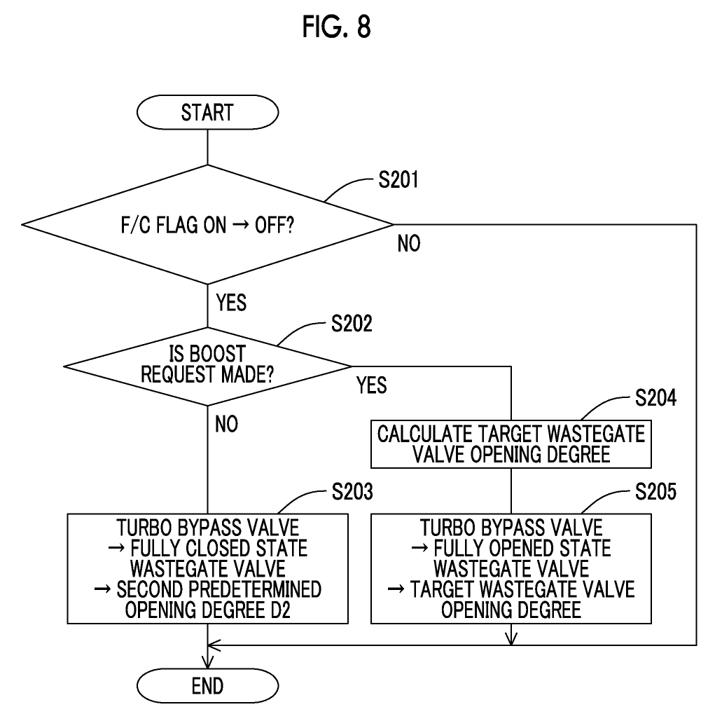

Next, a flow of control of the opening degrees of the turbo bypass valve and the wastegate valve at the time of execution of the fuel cut control and at the end of the fuel cut control will be described based on FIG. 7 and FIG. 8. FIG. 7 is a flowchart illustrating a flow of control of the opening degrees of the turbo bypass valve and the wastegate valve at the time of execution of the fuel cut control. FIG. 8 is a flowchart illustrating a flow of control of the opening degrees of the turbo bypass valve and the wastegate valve at the end of the fuel cut control. The flows are realized by executing a program that is stored in advance in the ECU 10.

First, the flow of control of the opening degrees of the turbo bypass valve and the wastegate valve at the time of execution of the fuel cut control will be described. In the flow illustrated in FIG. 7, in S101, a determination as to whether or not a fuel cut flag (F/C flag) is changed to ON from OFF is performed. The fuel cut flag is a flag that is switched to ON from OFF when a fuel cut control execution condition is established after the operating state of the internal combustion engine 1 is changed to a decelerating operation. When a negative determination is made in S101, execution of the present flow is temporarily finished.

When a positive determination is made in S101, the fuel cut control is executed. The fuel cut control is realized by the ECU 10 executing a fuel injection control flow different from the present flow and stopping fuel injection from each fuel injection valve 3. The ECU 10 that executes the fuel cut control in the present embodiment is one example of a “fuel cut control execution unit” according to the present disclosure. The fuel cut flag is maintained to be ON until a fuel cut control end condition is established. While the fuel cut flag is maintained to be ON, the fuel cut control is continued. That is, the stoppage of fuel injection from each fuel injection valve 3 is continued.

In the present flow, when a positive determination is made in S101, then in S102, the turbo bypass valve 53 is controlled to be in the fully closed state, and the opening degree of the wastegate valve 54 is controlled to the first predetermined opening degree D1.

As described above, the first predetermined opening degree D1 is an opening degree that is set such that the bypass gas flows into the first predetermined area A1 on the upstream side end surface 51a of the three-way catalyst 51. The first predetermined opening degree D1 can be determined in advance by experiment and the like. While the fuel cut control is continued, the turbo bypass valve 53 is maintained in the fully closed state, and the opening degree of the wastegate valve 54 is maintained at the first predetermined opening degree D1.

Next, the flow of control of the opening degrees of the turbo bypass valve and the wastegate valve at the end of the fuel cut control will be described. In the flow illustrated in FIG. 8, in S201, a determination as to whether or not the fuel cut flag (F/C flag) is changed to OFF from ON is performed. When the accelerator operation amount is increased during the decelerating operation of the internal combustion engine 1, the fuel cut control end condition is established, and the fuel cut flag is changed to OFF from ON. When a negative determination is made in S201, execution of the present flow is temporarily finished. In such a case, the fuel cut flag is maintained to be ON, and the fuel cut control is continued. When a positive determination is made in S201, the fuel cut control of the internal combustion engine 1 is ended. That is, fuel injection from each fuel injection valve 3 is resumed in the internal combustion engine 1 by the ECU 10 executing a fuel injection control flow different from the present flow.

In the present flow, when a positive determination is made in S201, then in S202, a determination as to whether or not a boost request is made for the internal combustion engine 1 is performed. The determination as to whether or not a boost request is made for the internal combustion engine 1 is performed based on a requested engine load that is determined in accordance with the accelerator operation amount detected by the accelerator position sensor 15 when the fuel cut flag is changed to OFF from ON. That is, when the requested engine load belongs to a boost area having a higher engine load than a predetermined engine load, a determination is made that a boost request is made for the internal combustion engine 1. When the requested engine load belongs to a natural air supply area having an engine load lower than or equal to the predetermined engine load, a determination is made that a boost request is not made for the internal combustion engine 1.

When a negative determination is made in S202, that is, when a boost request is not made for the internal combustion engine 1, then in S203, the turbo bypass valve 53 is maintained in the fully closed state, and the opening degree of the wastegate valve 54 is controlled to the second predetermined opening degree D2. As described above, the second predetermined opening degree D2 is an opening degree that is larger than the first predetermined opening degree D1 (for example, an opening that corresponds to the fully opened state), and is an opening degree that is set such that the bypass gas flows into the second predetermined area A2 on the upstream side end surface 51a of the three-way catalyst 51. The second predetermined opening degree D2 can be determined in advance by experiment and the like.

When a positive determination is made in S202, that is, when a boost request is made for the internal combustion engine 1, then in S204, a target wastegate valve opening degree is calculated. A relationship between the requested boost pressure and the target wastegate valve opening degree is stored as a map or a function in the ECU 10. In S204, the target wastegate valve opening degree that corresponds to the requested boost pressure is calculated by using the map or the function. Then, in S205, the turbo bypass valve 53 is controlled to be in the fully opened state, and the opening degree of the wastegate valve 54 is controlled to the target wastegate valve opening degree calculated in S204.

After a negative determination in S202, when, in S203, the turbo bypass valve 53 is maintained in the fully closed state, and the opening degree of the wastegate valve 54 is controlled to the second predetermined opening degree D2, the opening degrees of the turbo bypass valve and the wastegate valve may be maintained until a boost request is made for the internal combustion engine 1. When a boost request is made for the internal combustion engine 1, the turbo bypass valve 53 may be controlled to be in the fully opened state, and the opening degree of the wastegate valve 54 may be controlled to the target wastegate valve opening degree corresponding to the requested boost pressure, in the same manner as S205.

Controlling the opening degrees of the turbo bypass valve 53 and the wastegate valve 54 by the control flows illustrated in FIG. 7 and FIG. 8 can suppress a decrease in the NOx control efficiency of the three-way catalyst 51 at the end of the fuel cut control.

In the present embodiment, the first predetermined opening degree D1 of the wastegate valve 54 is set to an opening degree with which the area of inflow of the bypass gas on the upstream side end surface 51a of the three-way catalyst 51 becomes the first predetermined area A1 on the outer side from the second predetermined area A2 that is an area including the center portion on the upstream side end surface 51a. The second predetermined opening degree D2 of the wastegate valve 54 is set to an opening degree with which the area of inflow of the bypass gas on the upstream side end surface 51a of the three-way catalyst 51 becomes the second predetermined area A2 that is an area including the center portion on the upstream side end surface 51a. However, the first predetermined opening degree D1 and the second predetermined opening degree D2 according to the present embodiment are not limited to such opening degrees. That is, the effect according to the present embodiment can be achieved, provided that the wastegate valve 54 and the three-way catalyst 51 are configured such that the area of inflow of the bypass gas when the opening degree of the wastegate valve 54 is controlled to the first predetermined opening degree D1 is in a different position on the upstream side end surface 51a of the three-way catalyst 51 from the area of inflow of the bypass gas when the opening degree of the wastegate valve 54 is controlled to the second predetermined opening degree D2.

### Second Embodiment

A schematic configuration of an internal combustion engine and an intake and exhaust system of the internal combustion engine according to the present embodiment is the same as the first embodiment. In the present embodiment as well, the same control of the opening degrees of the turbo bypass valve 53 and the wastegate valve 54 as the first embodiment is executed during execution of the fuel cut control and at the end of the fuel cut control. The difference between the present embodiment and the first embodiment is that at the end of the fuel cut control, an enrichment process that decreases the air-fuel ratio of gas (exhaust gas) flowing into the three-way catalyst 51 to a low rich air-fuel ratio lower than the stoichiometric air-fuel ratio is executed in the present embodiment.

The enrichment process is executed by increasing the amount of fuel injection from each fuel injection valve 3 with respect to the amount of intake air detected by the air flow meter 43 further than usual (that is, when the air-fuel ratio of the air-fuel mixture is controlled to the stoichiometric air-fuel ratio). That is, in the enrichment process, the amount of fuel injection from each fuel injection valve 3 is increased further than an amount corresponding to the engine load corresponding to the accelerator operation amount. By executing the enrichment process, a larger amount of a fuel component than usual can be supplied to the three-way catalyst 51. Thus, oxygen that is retained in the three-way catalyst 51 can be consumed more quickly. Accordingly, the oxidized three-way catalyst 51 can be reduced more quickly, and the NOx control function of the three-way catalyst 51 can be recovered more quickly.

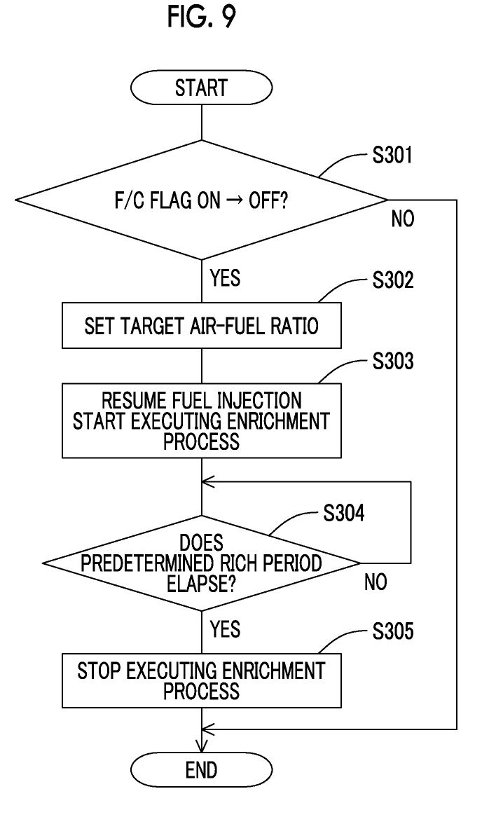

A flow of the enrichment process according to the present embodiment will be described based on a flowchart illustrated in FIG. 9. The present flow is realized by executing a program that is stored in advance in the ECU 10. “Execution of an enrichment process” according to the present disclosure is realized by the ECU 10 realizing the present flow in the present embodiment.

In the present flow, first in S301, a determination as to whether or not the fuel cut flag (F/C flag) is changed to OFF from ON is performed. The process in S301 is the same as the process in S201 in the flow illustrated in FIG. 8. When a negative determination is made in S301, execution of the present flow is temporarily finished. In such a case, the fuel cut flag is maintained to be ON, and the fuel cut control is continued.

When a positive determination is made in S301, then in S302, a target air-fuel ratio of gas (exhaust gas) in the enrichment process executed in a step described below is set. In the present embodiment, the ECU 10 constantly calculates the amount of oxygen retained in the three-way catalyst 51. The amount of oxygen retained in the three-way catalyst 51 is calculated by calculating the sum of the amount of oxygen (amount of increase) stored in the three-way catalyst 51 per unit time period and the amount of oxygen (amount of decrease) consumed per unit time period for an oxidation reaction in the three-way catalyst 51. The ECU 10 calculates the amount of oxygen retained in the three-way catalyst 51 even during execution of the fuel cut control.

The amount of oxygen supplied to the three-way catalyst 51 is increased during execution of the fuel cut control. Thus, the amount of oxygen retained in the three-way catalyst 51 is surely increased during execution of the fuel cut control. In the present embodiment as well, the same control of the opening degrees of the turbo bypass valve 53 and the wastegate valve 54 as the first embodiment is executed. Thus, a part of the three-way catalyst 51 through which the bypass gas (air) flows during execution of the fuel cut control is restricted to the part of the three-way catalyst 51 that has the first predetermined area A1 as the upstream side end surface and extends in the axial direction of the three-way catalyst 51. Thus, the amount of increase in the amount of oxygen retained in the three-way catalyst 51 during execution of the fuel cut control is decreased further than when air flows through approximately the entire area in the horizontal cross-sectional direction of the three-way catalyst 51 during execution of the fuel cut control. The ECU 10 calculates the amount of oxygen retained in the three-way catalyst 51 during execution of the fuel cut control, based on such a fact that a part of the three-way catalyst 51 through which the bypass gas (air) flows during execution of the fuel cut control is restricted.

In S302, the target air-fuel ratio of exhaust gas in the enrichment process is set in accordance with the amount of oxygen retained in the three-way catalyst 51 at the end of execution of the fuel cut control. That is, as the amount of oxygen retained in the three-way catalyst 51 at the end of execution of the fuel cut control is larger, the target air-fuel ratio of exhaust gas in the enrichment process is set to a lower value. A correlation between the amount of oxygen retained in the three-way catalyst 51 at the end of execution of the fuel cut control and the target air-fuel ratio of exhaust gas in the enrichment process is determined in advance by experiment and the like, and is stored as a map or a function in the ECU 10. In S302, the target air-fuel ratio of exhaust gas in the enrichment process is set by using the map or the function.

Then, in S303, fuel injection from each fuel injection valve 3 is resumed in the internal combustion engine 1. That is, the fuel cut control of the internal combustion engine 1 is ended. At the same time, execution of the enrichment process is started. During execution of the enrichment process, the amount of fuel injection from each fuel injection valve 3 is controlled such that the air-fuel ratio of exhaust gas becomes equal to the target air-fuel ratio set in S302.

Then, in S304, a determination as to whether or not a predetermined rich period elapses from the start of execution of the enrichment process in S303 is performed. The predetermined rich period is a period in which the three-way catalyst 51 is expected to be sufficiently reduced by executing the enrichment process. The predetermined rich period is determined in advance by experiment and the like. When a negative determination is made in S304, the process of S304 is executed again. That is, execution of the enrichment process is continued while the predetermined rich period elapses from the start of execution of the enrichment process. When a positive determination is made in S304, then in S305, execution of the enrichment process is stopped. That is, the amount of fuel injection from each fuel injection valve 3 is decreased to the amount corresponding to the engine load corresponding to the accelerator operation amount. In the present embodiment, when the turbo bypass valve 53 is maintained in the fully closed state, and the opening degree of the wastegate valve 54 is controlled to the second predetermined opening degree D2 due to having no boost request for the internal combustion engine 1 at the end of the fuel cut control, the opening degrees of the turbo bypass valve 53 and the wastegate valve 54 may be controlled to opening degrees corresponding to a usual operating state of the internal combustion engine 1 at a timing at which execution of the enrichment process is stopped.

As described above, in the enrichment process, the target air-fuel ratio of exhaust gas is set in accordance with the amount of oxygen retained in the three-way catalyst 51 at the end of execution of the fuel cut control. In the present embodiment as well, the same control of the opening degrees of the turbo bypass valve 53 and the wastegate valve 54 as the first embodiment is executed. Thus, the amount of oxygen retained in the three-way catalyst 51 at the end of execution of the fuel cut control can be decreased further than when air flows through approximately the entire area in the horizontal cross-sectional direction of the three-way catalyst 51 during execution of the fuel cut control. Accordingly, according to the present embodiment, the target air-fuel ratio of exhaust gas in the enrichment process can be set to be higher than when air flows through approximately the entire area in the horizontal cross-sectional direction of the three-way catalyst 51 during execution of the fuel cut control. Accordingly, the amount of fuel consumed for the enrichment process that is executed at the end of the fuel cut control can be reduced.

In the present embodiment, instead of the target air-fuel ratio of exhaust gas in the enrichment process, or in addition to the target air-fuel ratio, the length of the predetermined rich period that is the period of execution of the enrichment process may be set in accordance with the amount of oxygen retained in the three-way catalyst 51 at the end of execution of the fuel cut control. That is, as the amount of oxygen retained in the three-way catalyst 51 at the end of execution of the fuel cut control is larger, the length of the predetermined rich period may be set to a larger value. In such a case, a correlation between the predetermined rich period and the amount of oxygen retained in the three-way catalyst 51 at the end of execution of the fuel cut control is determined in advance and is stored as a map or a function in the ECU 10. The predetermined rich period is set by using the map or the function.

According to the present embodiment, as described above, when the predetermined rich period is set in accordance with the amount of oxygen retained in the three-way catalyst 51 at the end of execution of the fuel cut control, the predetermined rich period can be set to be shorter than when air flows through approximately the entire area in the horizontal cross-sectional direction of the three-way catalyst 51 during execution of the fuel cut control. Thus, the amount of fuel consumed for the enrichment process that is executed at the end of the fuel cut control can be reduced.

In the present embodiment, an air-fuel ratio sensor may be disposed in the exhaust passage 5 downstream of the three-way catalyst 51. The air-fuel ratio sensor detects the air-fuel ratio of exhaust gas (hereinafter, referred to as “outflow exhaust gas”) flowing out from the three-way catalyst 51. In such a case, when the air-fuel ratio of the outflow exhaust gas detected by the air-fuel ratio sensor during execution of the enrichment process becomes less than or equal to a predetermined air-fuel ratio that is a threshold for stopping the enrichment process, execution of the enrichment process may be stopped. While the fuel component that is supplied to the three-way catalyst 51 by executing the enrichment process is oxidized by oxygen retained in the three-way catalyst 51, the air-fuel ratio of the outflow exhaust gas is maintained at the stoichiometric air-fuel ratio. When all oxygen retained in the three-way catalyst 51 is consumed for oxidation of the fuel component, the fuel component passes through the three-way catalyst 51, and the air-fuel ratio of the outflow exhaust gas becomes a low rich air-fuel ratio lower than the stoichiometric air-fuel ratio. The predetermined air-fuel ratio is a low rich air-fuel ratio that is lower than the stoichiometric air-fuel ratio, and is determined in advance by experiment and the like as an air-fuel ratio with which a determination can be made that all oxygen retained in the three-way catalyst 51 is consumed for oxidation of the fuel component.

Even when the timing of stopping execution of the enrichment process is determined as described above, the period of execution of the enrichment process is lengthened as the amount of oxygen retained in the three-way catalyst 51 at the end of execution of the fuel cut control is larger. Accordingly, according to the present embodiment, even when the timing of stopping execution of the enrichment process is determined as described above, the period of execution of the enrichment process can be shortened further than when air flows through approximately the entire area in the horizontal cross-sectional direction of the three-way catalyst 51 during execution of the fuel cut control. Thus, the amount of fuel consumed for the enrichment process that is executed at the end of the fuel cut control can be reduced.

In an exhaust system according to an aspect of the present disclosure, the wastegate valve and the three-way catalyst may be configured such that the bypass gas flows into the first predetermined area on the upstream side end surface of the three-way catalyst when the opening degree of the wastegate valve is controlled to the first predetermined opening degree. The first predetermined area may be an area on the outer side from the second predetermined area that is an area including the center portion on the upstream side end surface of the three-way catalyst. The wastegate valve and the three-way catalyst may be configured such that the bypass gas flows into the second predetermined area on the upstream side end surface of the three-way catalyst when the opening degree of the wastegate valve is controlled to the second predetermined opening degree larger than the first predetermined opening degree. According to the aspect of the present disclosure, the area of inflow of the bypass gas on the upstream side end surface of the three-way catalyst during execution of the fuel cut control can be in a different position from when the fuel cut control is ended.

In the exhaust system according to the aspect of the present disclosure, the electronic control unit may be configured to control the turbo bypass valve to be in the fully opened state and control the opening degree of the wastegate valve to an opening degree corresponding to a requested boost pressure when a boost request is made for the internal combustion engine at the end of the fuel cut control. In such a case, at the end of the fuel cut control, not only the bypass gas that is guided by the wastegate valve, but also gas (exhaust gas) that passes through the turbine flows into the three-way catalyst. Thus, exhaust gas flows into the three-way catalyst from approximately the entire upstream side end surface of the three-way catalyst. Thus, exhaust gas flows through the part of the three-way catalyst that is oxidized during execution of the fuel cut control. However, even in such a case, a decrease in the NOx control efficiency of the three-way catalyst at the end of the fuel cut control can be suppressed further than when the three-way catalyst is oxidized across approximately the entire area in the horizontal cross-sectional direction of the three-way catalyst during execution of the fuel cut control.

In the exhaust system according to the aspect of the present disclosure, the electronic control unit may be configured to execute the enrichment process that decreases an air-fuel ratio of gas flowing into the three-way catalyst to a low rich air-fuel ratio lower than the stoichiometric air-fuel ratio, at the end of the fuel cut control. By executing the enrichment process by the electronic control unit at the end of the fuel cut control, oxygen that is retained in the three-way catalyst can be consumed more quickly. Accordingly, the oxidized three-way catalyst can be reduced more quickly, and the NOx control function of the three-way catalyst can be recovered more quickly.

The electronic control unit may be configured to determine the target air-fuel ratio of gas (exhaust gas) in the enrichment process or the period of execution of the enrichment process in accordance with the amount of oxygen retained in the three-way catalyst at the end of execution of the fuel cut control. That is, as the amount of oxygen retained in the three-way catalyst at the end of execution of the fuel cut control is larger, the target air-fuel ratio of exhaust gas in the enrichment process may be set to be lower. As the amount of oxygen retained in the three-way catalyst at the end of execution of the fuel cut control is larger, the period of execution of the enrichment process may be set to be longer.

In such a case, as the amount of oxygen retained in the three-way catalyst at the end of execution of the fuel cut control is larger, the amount of fuel consumed for the enrichment process is increased. In the present disclosure, as described above, air flows through the three-way catalyst through a partial area in the horizontal cross-sectional direction of the three-way catalyst and not through the entire area in the horizontal cross-sectional direction of the three-way catalyst during execution of the fuel cut control. Thus, the amount of oxygen retained in the three-way catalyst at the end of execution of the fuel cut control can be decreased further than when air flows through approximately the entire area in the horizontal cross-sectional direction of the three-way catalyst during execution of the fuel cut control. Accordingly, the amount of fuel consumed for the enrichment process that is executed at the end of the fuel cut control can be reduced.

What is claimed is:

1. An exhaust system of an internal combustion engine, the exhaust system comprising:
a turbocharger that includes a turbine disposed in an exhaust passage of the internal combustion engine, and a compressor disposed in an intake passage of the internal combustion engine;
a bypass passage that branches off from the exhaust passage upstream of the turbine and merges with the exhaust passage downstream of the turbine;
a wastegate valve that is disposed at an exit of the bypass passage and is configured to change a channel cross-sectional area of gas at the exit of the bypass passage, the wastegate valve including a valve body portion supported on a single side, the wastegate valve being configured to change an opening degree by swinging the valve body portion, the wastegate valve being configured to change a flow direction of bypass gas in accordance with the change in opening degree, and the bypass gas being gas flowing out from the exit of the bypass passage;
a turbo bypass valve that is disposed between a branch portion of the exhaust passage where the bypass passage branches off from the exhaust passage, and a merging portion of the exhaust passage where the bypass passage merges with the exhaust passage, and is configured to change the channel cross-sectional area of gas passing through the turbine;
a three-way catalyst that is disposed immediately downstream of the merging portion of the exhaust passage where the bypass passage merges with the exhaust passage, the three-way catalyst being disposed in a position in which an area of inflow of the bypass gas on an upstream side end surface of the three-way catalyst is changed in accordance with the change in the flow direction of the bypass gas; and
an electronic control unit configured to
execute fuel cut control that stops fuel injection to the internal combustion engine, at a time of a decelerating operation,
control the turbo bypass valve to be in a fully closed state and control the opening degree of the wastegate valve to a first predetermined opening degree during execution of the fuel cut control, and
maintain the turbo bypass valve in the fully closed state and control the opening degree of the wastegate valve to a second predetermined opening degree different from the first predetermined opening degree when a boost request is not made for the internal combustion engine at an end of the fuel cut control,
wherein the wastegate valve and the three-way catalyst are configured such that an area of inflow of the bypass gas on the upstream side end surface of the three-way catalyst when the opening degree of the wastegate valve is controlled to the first predetermined opening degree is in a different position from the area of inflow of the bypass gas on the upstream side end surface of the three-way catalyst when the opening degree of the wastegate valve is controlled to the second predetermined opening degree.

2. The exhaust system according to claim 1, wherein:
the wastegate valve and the three-way catalyst are configured such that the bypass gas flows into a first predetermined area on the upstream side end surface of the three-way catalyst when the opening degree of the wastegate valve is controlled to the first predetermined opening degree, the first predetermined area being an area on an outer side from a second predetermined area that is an area including a center portion on the upstream side end surface of the three-way catalyst; and
the wastegate valve and the three-way catalyst are configured such that the bypass gas flows into the second predetermined area on the upstream side end surface of the three-way catalyst when the opening degree of the wastegate valve is controlled to the second predetermined opening degree larger than the first predetermined opening degree.

3. The exhaust system according to claim 1, wherein the electronic control unit is configured to control the turbo bypass valve to be in a fully opened state and control the opening degree of the wastegate valve to an opening degree corresponding to a requested boost pressure when a boost request is made for the internal combustion engine at the end of the fuel cut control.

4. The exhaust system according to claim 1, wherein:
the electronic control unit is configured to execute an enrichment process that decreases an air-fuel ratio of gas flowing into the three-way catalyst to a low rich air-fuel ratio lower than a stoichiometric air-fuel ratio, at the end of the fuel cut control; and
the electronic control unit is configured to determine a target air-fuel ratio of gas in the enrichment process or a period of execution of the enrichment process in accordance with an amount of oxygen retained in the three-way catalyst at the end of execution of the fuel cut control.
